(19) United States
(12) Patent Application Publication
(10) Pub. No.: US 2007/0063983 A1
(43) Pub. Date: Mar. 22, 2007

(54) Layout of touch panel for a voiding moires

(75) Inventors: Ping-Wen Huang, Taichung City (TW); Chiu-Mei Liu, Taichung City (TW); Ming-Kung Wu, Taichung County (TW); Shyang-Shyan Tseng, Taichung City (TW); Chun-Hao Wang, Changhua County (TW); Li-Fen Lin, Taichung County (TW); Sung-Hao Chu, Taichung City (TW); Di-Shing Tsai, Taichung County (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/230,461

(22) Filed: Sep. 21, 2005

(51) Int. Cl. G09G 5/00

(52) U.S. Cl. 345/173

(57) ABSTRACT

This invention is a kind of layout of touch panel for avoiding moires, which deploys a transparent conductive layout on the touch panel, and let the open area of the transparent conductive layout discontinuous match and cover the corresponding sub-pixels of the display such that the behavior of the display brightness passing through the open area of the transparent conductive layout is dispersed sufficiently so as to avoid the difference of the display brightness passing through the open area sensed by human eyes, and then to avoid moires generated on the touch panel.

### FIELD OF THE INVENTION

The present invention relates to a touch panel, especially to a kind of layout of touch panel for avoiding moires on the display.

### BACKGROUND OF THE INVENTION

Following the development of technology and the trend of digitizing for products, various kinds of information products have become indispensable for daily life. For people to use and control information products, information products equip input interfaces and output interfaces. The most easily portable and humanized design is the touch panel that forms together with a screen.

Touch panels are glass panels that are constructed by conductive glass and conductive films, which are input devices that display needed images on the screen by touch-control method through bus-line and control IC of the circuit board.

Based on the humanized characteristics for input interface, almost without any teaching or learning, users can point to choose the needed function according to the instruction on the screen by fingers or touch-control pens directly. The scope of utilization is very wide. The main utilization includes:
1. Portable communication, consumer electronics, and information products: such as PDA, palm-sized PC, electronic dictionary, handwriting input device, information appliance, new generation digital broadband mobile-phone (includes 3G and GPRS phones), and stock-market information display (Eten Info Touch for example).
2. Finance/Business utilization: such as money-withdrawing/ticket-selling system, sale system, remote videoconference, and telephone terminal system.
3. Medical and Hygienic utilization: such as registration system, operation platform monitoring, and medical tracing.
4. Industrial utilization: such as automatic controlled system for factories, remote/central monitoring system, workstation operation system, and management information system (MIS).
5. Public information utilization: airport guidance system, cultural relics introduction system, and land administration inquiring system; and
6. Teaching/TV-game utilization: game facilities in a recreation center, and computer-aided teaching for children.

According to different working principles, touch panels can be divided into: digital-resistor type, digital-capacitor type, digital-inductor type, sound-wave type, light conductive wave type, load-variation type etc. However, the digital-resistor type is the most widely used among them.

The technical principles of the film on glass (FOG) are that wire routes the Indium Tin Oxide (ITO) glass and ITO film according to X and Y-axes. There is a dot spacer between them. Depress the upper electrode by fingers, pens, or other materials to connect the upper and lower electrodes indirectly so as to induce a potential difference. The interlaced portion of the upper and lower circuits forms a switch that produces ON/OFF functions by depressing the switch. The ON/OFF signal is passed through a bus-line to the controller to be processed, and the coordinate location of the depressed place can be further calculated.

Please refer to FIGS. 1, 2, 3, and 4. The transparent conductive layout 2 of the well-known touch panel 1 is a linearized design, and a general display 3 has sub-pixels 6 arranged in matrix form. After the touch panel 1 superimposes the display 3, the display brightness 4 and 4a of the display 3 will pass through the touch panel 1. The touch panel 1 has the transparent conductive layout 2, and the transparent conductive layout 2 will reduce the light transmission of the display 3. Therefore, the transmission of the display brightness 4 and 4a of the display 3 will be different according to whether the lights pass the transparent conductive layout 2 or not. The display brightness 4 and 4a of the display 3 will have different luminance according to whether they pass through the transparent conductive layout 2 or not.

As the transparent conductive layout 2 of the well-known touch panel 1 is a linearized design, the open area 5 of the transparent conductive layout 2 continuously matches and covers the corresponding sub-pixels 6 of the display 3 (i.e. the open area 5 covers sub-pixels 6 that are on the same column or same row). The display brightness 4a of the display 3 passed through the open area 5 of the transparent conductive layout 2 so it has higher luminance, which has luminance difference A to the display brightness 4 that did not pass through the open area 5 of the transparent conductive layout 2. When the display brightness 4a gets together with higher luminance, it is easy to identify the difference via human eyes. As shown in FIG. 5, human eyes identify the moires produced by the display brightness 4a. At this time, the display 3 appears the phenomenon of moire which can be sensed by human eyes.

### SUMMARY OF THE INVENTION

Consequently, the main purpose of the present invention is to provide a kind of layout of touch panel for avoiding the phenomenon of moire on the display.

This invention is a kind of layout of touch panel for avoiding moires on the display, which is applied to touch panels. A transparent conductive layout is deployed on the touch panel, and the transparent conductive layout has at least one open area. The touch panel superimposed the display. The display has sub-pixels arranged in matrix form, and let the open area of the transparent conductive layout discontinuously match and cover the corresponding sub-pixels of the display such that the whole display brightness of the display is uniform so as to avoid that human eyes identify the difference.

### BRIEF DESCRIPTION FOR THE DRAWINGS

FIG. 1 is the schematic diagram for the layout of a well-known touch panel.

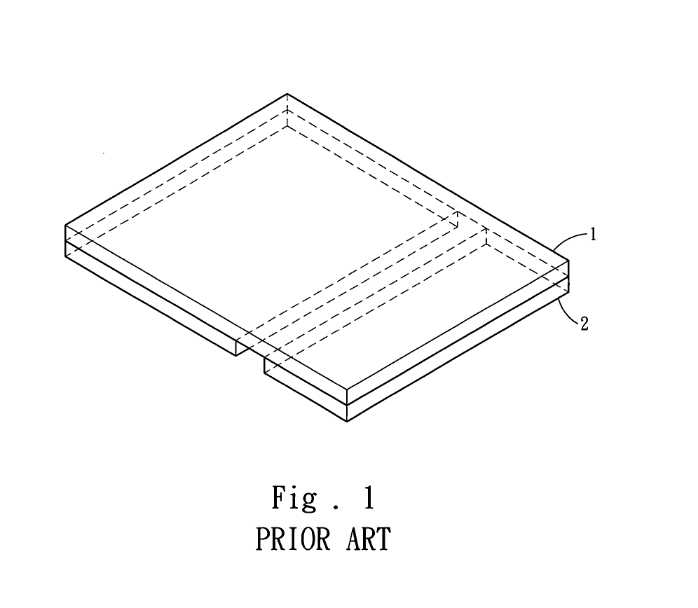

FIG. 2 is the schematic diagram for the pixel arrangement of a well-known display.

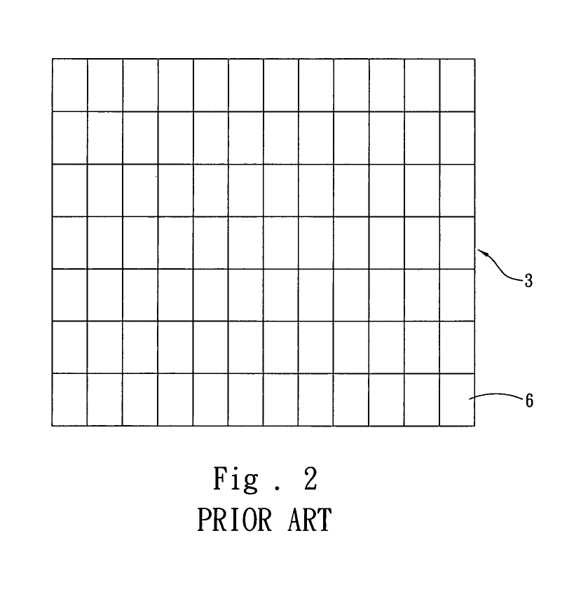

FIG. 3 shows the side-view of the combination after a well-known touch panel superimposed a display.

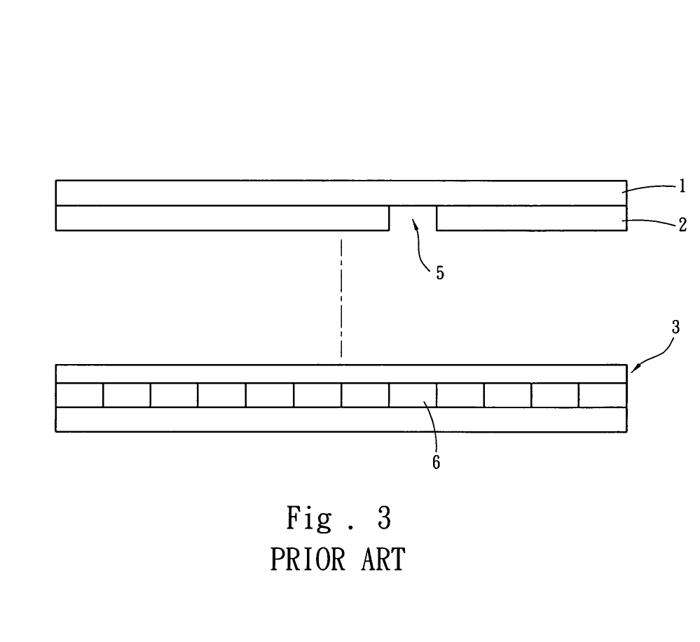

FIG. 4 is the schematic diagram for the brightness attenuation of a well-known display.

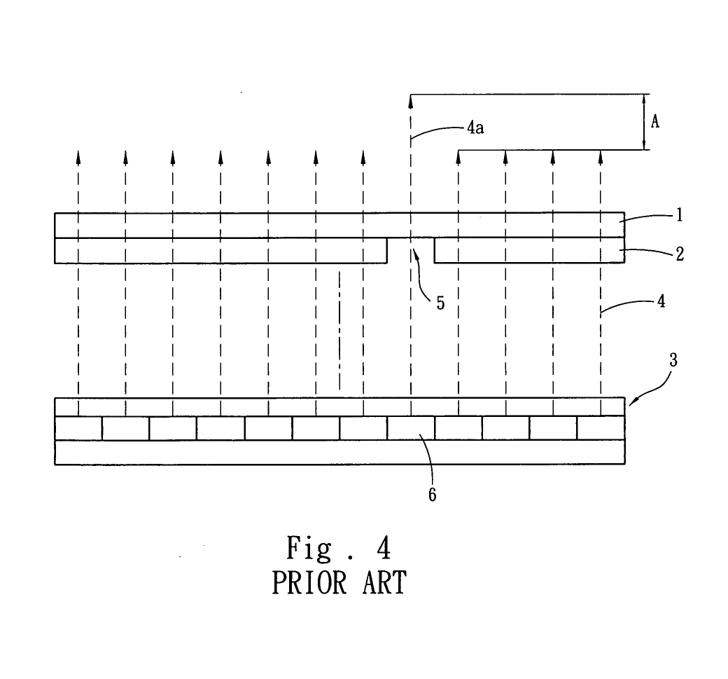

FIG. 5 is the displayed frame of a well-known display.

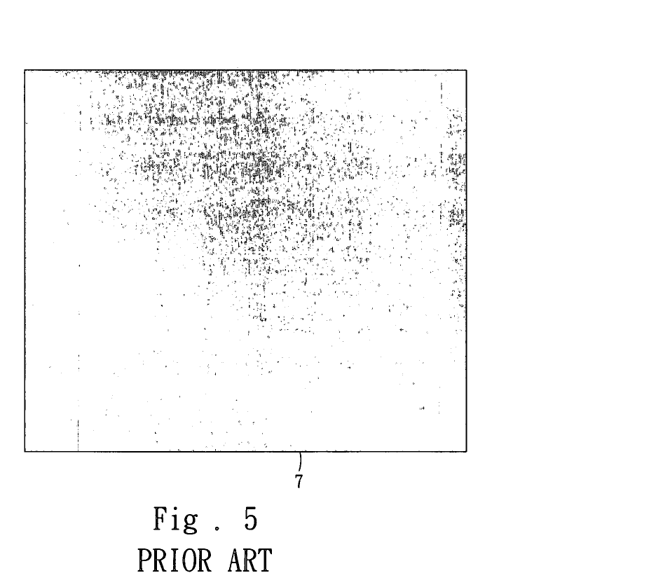

FIG. 6 is the schematic diagram for the layout of the touch panel of the present invention.

FIG. 7 is the schematic diagram for the pixel arrangement of the display of the present invention.

FIG. 8 is the first schematic diagram for the different-color pixels arrangement of the display of the present invention.

FIG. 9 is the second schematic diagram for the different-color pixels arrangement of the display of the present invention.

FIG. 10 is the third schematic diagram for the different-color pixels arrangement of the display of the present invention.

FIG. 11 shows the front-view of the combination after the touch panel superimposed the display of the present invention.

FIG. 12 shows the side-view of the combination after the touch panel superimposed the display of the present invention.

FIG. 13 is the schematic diagram for the brightness attenuation of the display of the present invention.

FIG. 14 is the dimension diagram for the layout of the touch panel of the present invention.

FIG. 15 is the displayed frame of the display of the present invention.

FIG. 16 is another schematic diagram for the layout of the touch panel of the present invention.

FIG. 17 is further another schematic diagram for the layout of the touch panel of the present invention.

### DETAILED DESCRIPTION OF THE PREFERRED EMBODIMENT

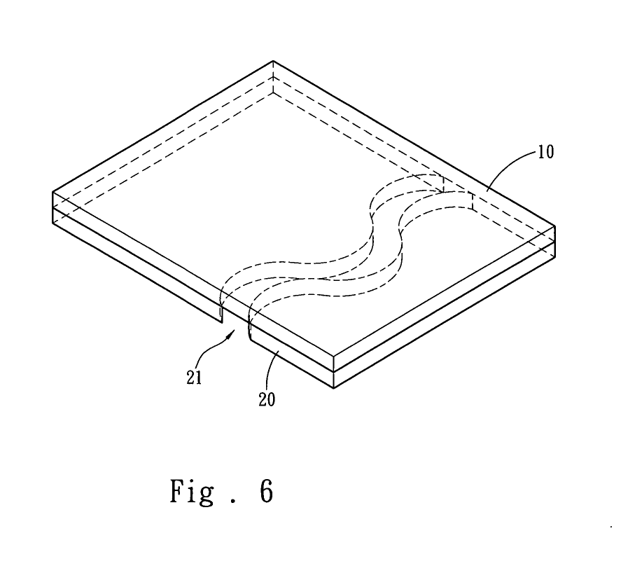

Please refer to FIG. 6. This invention deploys a transparent conductive layout 20 on the touch panel 10, and the transparent conductive layout 20 has at least one open area 21. The open area 21 is a waved shape. The material of the substrate of the touch panel 10 can be hard or soft materials such as glass, Polycarbonate (PC), Polymethyl methacrylate acrylic (PMMA), and Polyethylene terephthalate (PET) etc. The material of the transparent conductive layout 20 can be transparent conductive material such as Indium Tin Oxide (ITO), Antimony Tin Oxide (ATO), or Aluminum Zinc Oxide (AZO). Usually, the transparent conductive material is coated on the touch panel 10 by sputtering, evaporation etc. The open area 21 of the transparent conductive layout 20 can be manufactured either when transparent conductive film coating by way of a shielding mask or after transparent conductive film coating by way of photolithography.

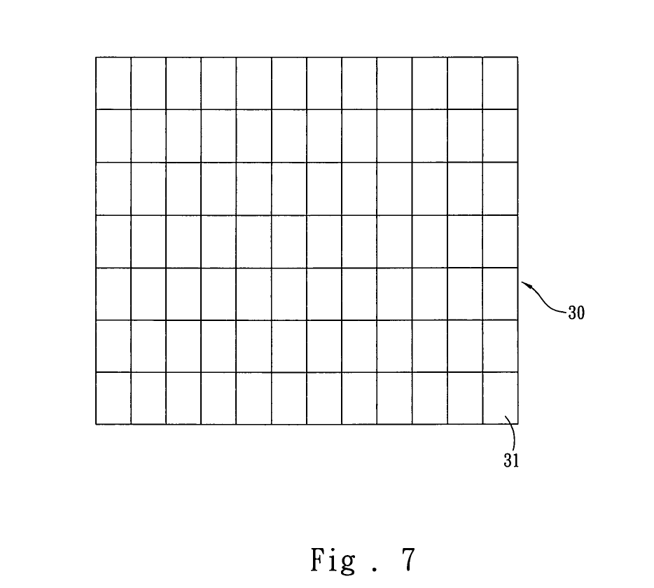

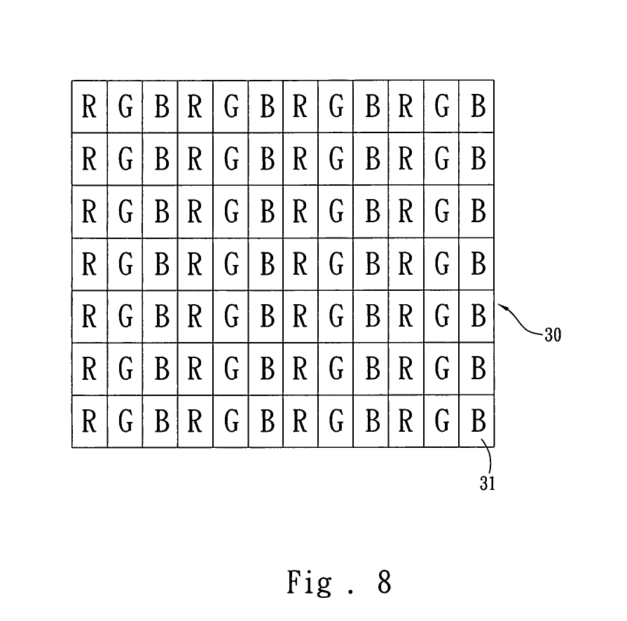

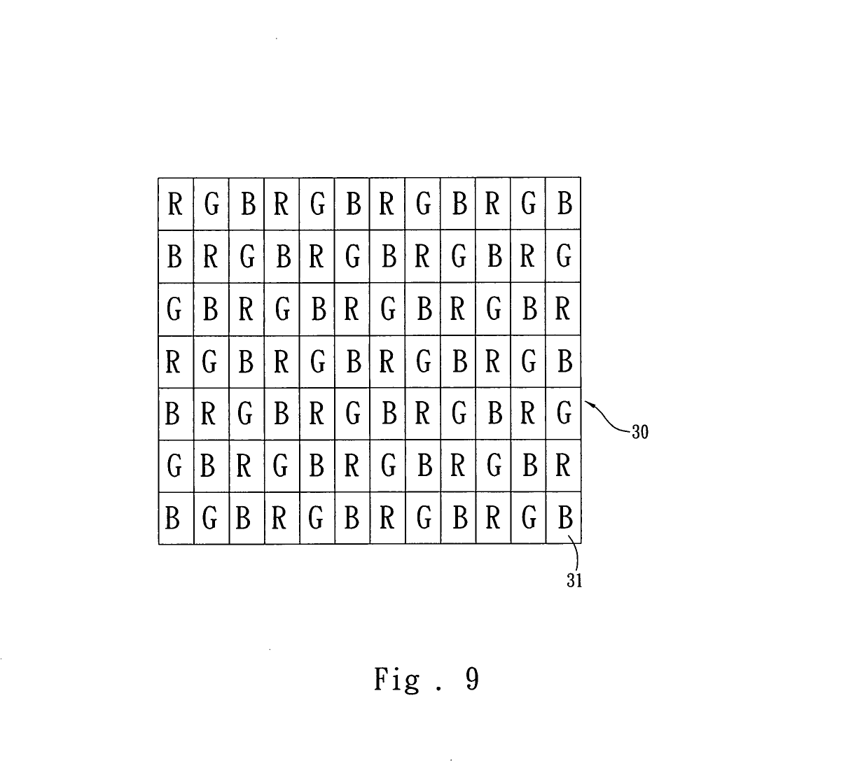

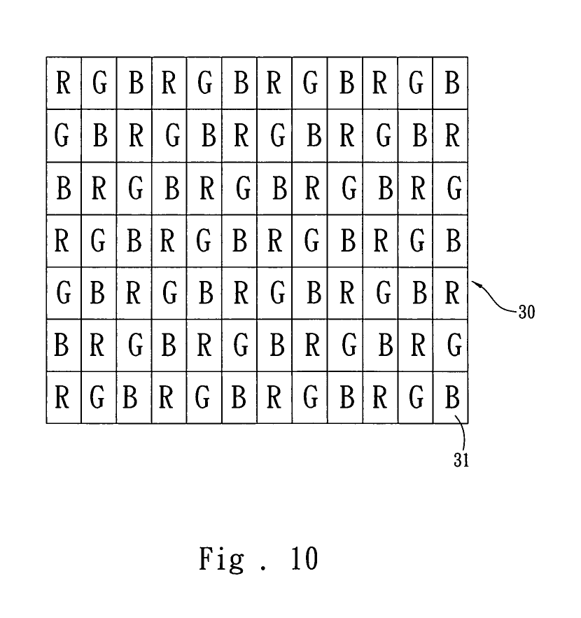

Please refer to FIG. 7. The display 30 of this invention has sub-pixels 31 arranged in matrix form. The sub-pixels 31 can be either a pixel formed by a single color or a pixel formed by a set of red, green, and blue colors. The arrangements for the different-color sub-pixels 31 are stripe type and mosaic type as shown in FIGS. 8, 9, and 10.

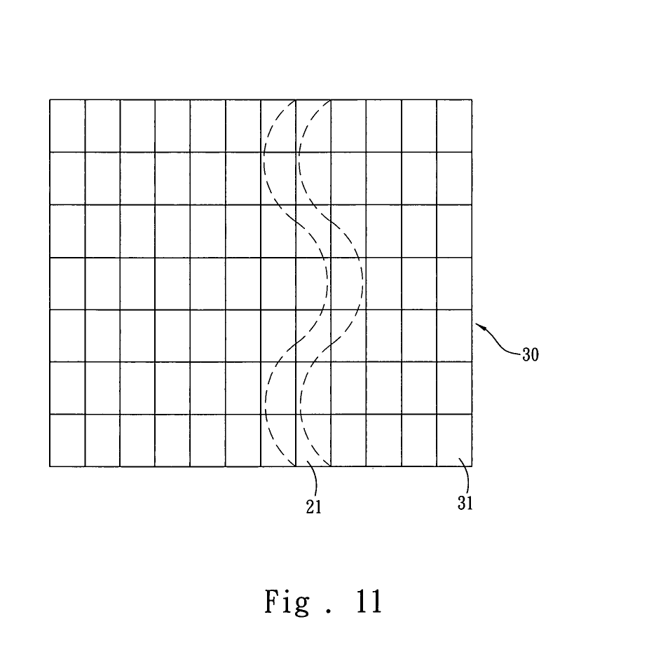

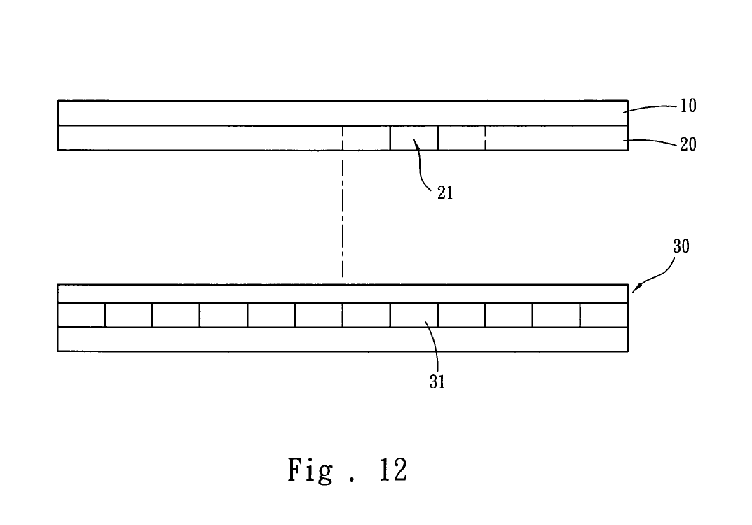

Please refer to FIGS. 11 and 12. The touch panel 10 superimposed the display 30. At this time, the open area 21 of the transparent conductive layout 20 is a waved shape and the sub-pixels 31 of the display 30 are arranged in matrix form. When the touch panel 10 superimposed the display 30, the open area 21 of the transparent conductive layout 20 will discontinuously match and cover the sub-pixels 31 of the display 30.

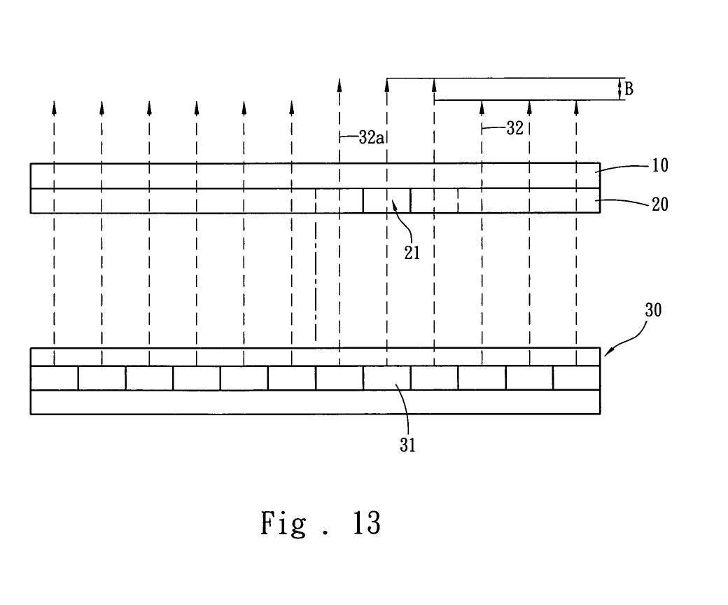

Please refer to FIG. 13 together. The display 30 emits display brightness 32 and 32a. Although the display brightness 32a passed through the open area 21 of the transparent conductive layout 20 has higher luminance, the open area 21 of the transparent conductive layout 20 is a waved shape that can reduce the luminance difference B between the display brightness 32 and 32a which pass the open area 21 or not. Therefore, the behavior of the luminance for the display brightness 32a passed through the open area 21 of the transparent conductive layout 20 is not continuously identical. Consequently, it is not easy for human eyes to identify the difference and the phenomenon of moire on the display 30 can be eliminated efficiently.

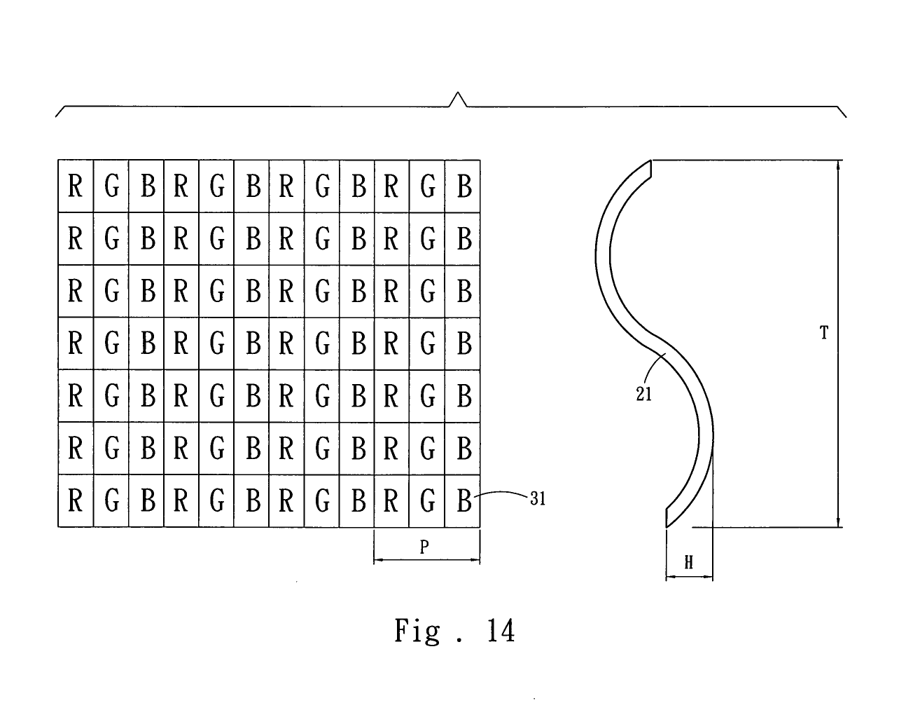

Please refer to FIG. 14. Assume that the dot pitch of the pixels is P, the amplitude of the waved shape of the transparent conductive layout 20 is H, and the wavelength is T. As long as equations H≧0.5 P and

$$0 \text{.} 1 \leq \frac{H}{T} \leq 0 \text{.} 61$$

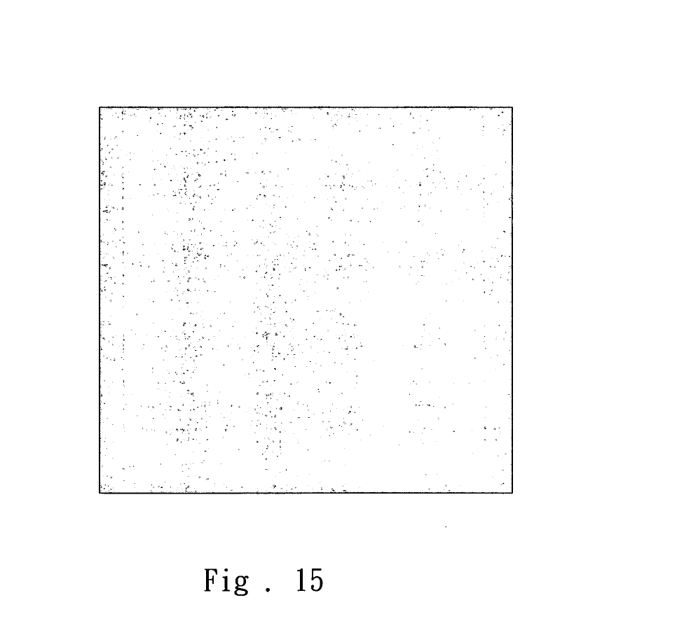

can be satisfied, the display brightness 32a passed through the open area 21 of the transparent conductive layout 20 can be dispersed sufficiently, which assures that the luminance difference between the display brightness 32a passing through the open area 21 of the transparent conductive layout 20 and the display brightness 32 not passing through the open area 21 will not be identified by human eyes easily. For the most people 15 with general eyesight, the display 30 does not produce the phenomenon of moire. For example, when p=0.297 mm, H=0.28 mm, T=1.27 mm, the frame of the display is shown in FIG. 15 where the phenomenon of moire is not seen.

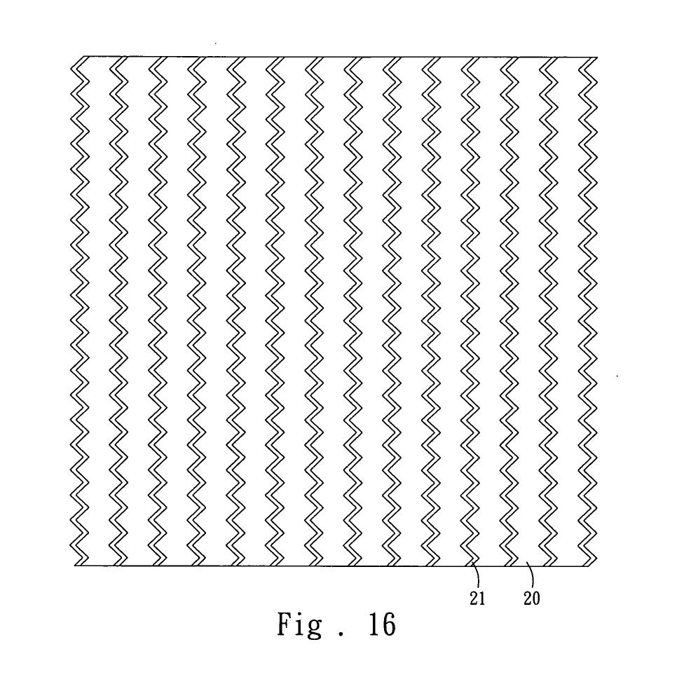

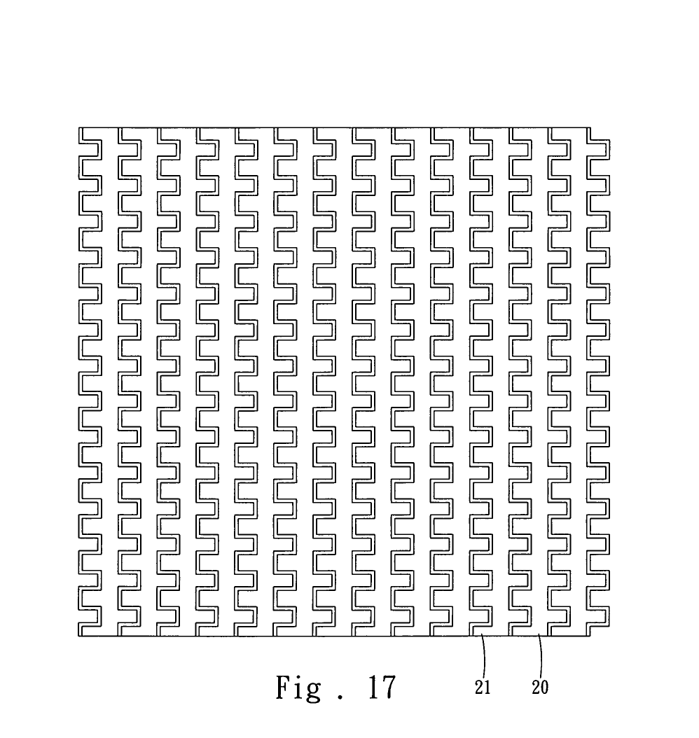

Please refer to FIGS. 16 and 17. The waved shape of the 20 transparent conductive layout 20, except the waved shape as shown in FIG. 6, the waved shape of the transparent conductive layout 20 also can be designed as saw-toothed shape or square-wave shape.

The two shapes also can let the open area 21 of the transparent conductive layout 20 discontinuously match and cover the sub-pixels 31 of the display 30. Therefore, the two shapes can also avoid the phenomenon of moire on display 30.

Besides, the open area 21 of the transparent conductive layout 20 also can be a lineal design but the design is not parallel to the matrix-arranged sub-pixels 31 and has an angle difference. The lineal design also can let the open area 21 of the transparent conductive layout 20 discontinuously match and cover the sub-pixels 31 of the display 30. Accordingly, the lineal design assures that the luminance difference between the display brightness 32a passing through the open area 21 of the transparent conductive layout 20 and the display brightness 32 not passing through the open area 21 will not be identified by human eyes easily. Therefore, the phenomenon of moire on the display 30 can be eliminated efficiently.

To sum up, the touch panel 10 can be applied to this invention including digital-resistor type touch panels, digital-capacitor type touch panels, and digital-inductor type touch panels. The display 30 can be applied to this invention including Active-Matrix LCD, Passive-Matrix LCD, or Emissive Display and so on. The transparent conductive layout 20 of this invention let the display brightness 32 of the display 30 reveal uniformly so as to eliminate the phenomenon of moire on the display 30 efficiently and then the image-display quality of the display 30 can be promoted.

Furthermore, having described the invention in connection with certain specific embodiments thereof, it is to be understood that further modifications may now suggest themselves to those skilled in the art, it is intended to cover all such modifications as fall within the scope of the appended claims.

What is claimed is:

1. A kind of layout of touch panel for avoiding moires applied to a display having sub-pixels arranged in matrix form, comprising:
a touch panel, which superimposed the display; and
a transparent conductive layout, which is deployed on the touch panel and has at least one open area, the open area of the transparent conductive layout discontinuously matching and covering the corresponding sub-pixels of the display.

2. The layout of touch panel as claimed in claim 1, wherein the open area of the transparent conductive layout is a lineal design and the design is not parallel to the matrix-arranged sub-pixels and has an angle difference.

3. The layout of touch panel as claimed in claim 1, wherein the open area of the transparent conductive layout is a waved shape.

4. The layout of touch panel as claimed in claim 3, wherein the sub-pixels of the display are that a set of red, green, and blue colors forming a pixel, the dot pitch of the pixel is P. the amplitude of the waved shape of the transparent conductive layout is H, the wavelength is T, and they satisfy equations H≧0.5 P and
$$0 \text{.} 1 \leq \frac{H}{T} \leq 0 \text{.} 61.$$

5. The layout of touch panel as claimed in claim 3, wherein the waved shape of the open area is a waved configuration.

6. The layout of touch panel as claimed in claim 3, wherein the waved shape of the open area is a saw-toothed configuration.

7. The layout of touch panel as claimed in claim 3, wherein the waved shape of the open area is a square-wave configuration.

8. The layout of touch panel as claimed in claim 1, wherein the touch panel is selected from the group consisting of digital- resistor type touch panel, digital-capacitor type touch panel, and digital-inductor type touch panel.

9. The layout of touch panel as claimed in claim 1, wherein the material of the substrate of the touch panel is selected from the group consisting of glass, Polycarbonate (PC), Polymethyl methacrylate acrylic (PMMA), and Polyethylene terephthalate (PET).

10. The layout of touch panel as claimed in claim 1, wherein the material of the transparent conductive layout is selected from the group consisting of Indium Tin Oxide (ITO), Antimony Tin Oxide (ATO), and Aluminum Zinc Oxide (AZO).

11. The layout of touch panel as claimed in claim 1, wherein the display is selected from the group consisting of Active-Matrix LCD, Passive-Matrix LCD, and Emissive Display.

12. A kind of layout of touch panel for avoiding moires, comprising: a touch panel;
a transparent conductive layout, which is deployed on the touch panel and has at least a open area, the open area of the transparent conductive layout being a waved shape.

13. The layout of touch panel as claimed in claim 12, wherein the waved shape of the open area is a waved configuration.

14. The layout of touch panel as claimed in claim 12, wherein the waved shape of the open area is a saw-toothed configuration.

15. The layout of touch panel as claimed in claim 12, wherein the waved shape of the open area is a square-wave configuration.

16. The layout of touch panel as claimed in claim 12, wherein the touch panel is selected from the group consisting of digital-resistor type touch panel, digital-capacitor type touch panel, and digital-inductor type touch panel.

17. The layout of touch panel as claimed in claim 12, wherein the material of the substrate of the touch panel is selected from the group consisting of glass, Polycarbonate (PC), Polymethyl methacrylate acrylic (PMMA), and Polyethylene terephthalate (PET).

18. The layout of touch panel as claimed in claim 12, wherein the material of the transparent conductive layout is selected from the group consisting of Indium Tin Oxide (ITO), Antimony Tin Oxide (ATO), and Aluminum Zinc Oxide (AZO).
